(19) United States
(12) Patent Application Publication
(10) Pub. No.: US 2003/0167685 A1
(43) Pub. Date: Sep. 11, 2003

(54) Method for producing miniature cranberries and a substantially full yield thereof

(76) Inventor: Jonathan D. Smith, Port Edwards, WI (US)

Correspondence Address: JANSSON, SHUPE & MUNGER, LTD, 245 MAIN STREET, RACINE, WI, 53403, US

(21) Appl. No.: 10/092,796

(22) Filed: Mar. 7, 2002

(51) Int. Cl. A01B 79/00

(52) U.S. Cl. 47/58.1 FV

(57) ABSTRACT

A method of enhancing and modifying the productivity of cranberry plants through commercial application of a plant-growth regulating composition to the plants during their bloom period to achieve a substantially consistent yield of miniature cranberries, and the yield of miniature cranberries that result therefrom. The method involves applying a plant-growth regulating composition, preferably gibberellin, to cranberry plants, most preferably during their mid-bloom period. The invention gives increased fruit set levels—80 % or even higher. In addition to higher fruit sets and, therefore, higher yields, application of the plant-growth regulator results in miniature parthenocarpic cranberries.

### FIELD OF THE INVENTION

This invention relates broadly to the field of plant productivity enhancement and modification. More specifically, the invention relates to methods for improving and modifying the productivity of plants used in commercial production of fruit and, still more specifically, to cranberry production.

### BACKGROUND OF THE INVENTION

As one of only a few native North American fruits, the cranberry was an important staple long before the Pilgrims arrived. Native Americans made cakes prepared with lean, dried strips of meat pounded into paste and mixed with animal fat, grains and cranberries.

Today, cranberries are enjoyed as fresh fruit, canned sauce, bottled juice, frozen concentrate, jams, sauces, relishes, and special low-calorie products. Many people enjoy muffins which include cranberries. During the production of such muffins, or other baked goods, cranberries are typically introduced to the batter before the muffins are baked. During the baking process, cranberries typically experience weeping, in which water in the cranberry cells is released. This results in the muffins being oversoaked from the released water. In addition, it usually causes the cranberries to change color to blue upon the loss of the water, which can be unappealing to consumers.

Cranberries are typically 0.9 g to 2.0 g which is often too large to be included inside muffins. Even if a baker considers that size of cranberry as not being too large to be eaten in a bite of a muffin, the muffin can be enjoyed more if it has an equal distribution of the cranberry. Therefore, cranberries are often sliced into pieces which can be dispersed throughout the muffin. However, the slicing of the cranberry exacerbates the weeping problem and adds a production step, increasing costs and labor.

People also enjoy cranberries with chocolate. However, the size of a typical cranberry prevents it from being easily combined with chocolate treats. If cranberries are sliced to circumvent this problem their shelf-life is dramatically reduced.

Therefore, cranberries having smaller volume and masses would be a significant improvement over typical cranberries. While a few small-sized cranberries may grow among typical-size cranberries on a cranberry plant due to myriad factors, the ability to successfully mass produce such cranberries is heretofore unknown. Mass production of miniature cranberries, cranberries which have a mature mass of less than 0.9 grams, would be a significant advance in the agricultural field.

In addition to the disadvantage of size, typical cranberries also present problems regarding their seeds. A problem experienced when eating typical cranberries is that cranberries seeds become stuck between teeth. Cranberry seeds also present problems during the juicing process. It is also believed that cranberries with seeds have shorter shelf-lives than parthenocarpic (seedless) cranberries. In addition, seedless fruits typically have higher total sugar levels than seeded fruit. Therefore, a method of growing seedless cranberries would provide more desirable cranberries for the consuming public and juice processors.

In addition to the above problems, cranberry growing has long been an inefficient process. Yields of cranberries in average number per plant and per acre historically have been low. That is, what is referred to as “fruit set” is seen as lower than desirable, and this has long been a source of frustration for commercial cranberry producers. A method of growing cranberries which increases the yield of cranberries, at least in terms of fruit set, would be a significant advance in the industry.

Certain work having a bearing on this subject has been conducted in the past, and is referenced below. However, prior work and development efforts have failed to achieve the objects achieved by the instant invention, as set forth below.

### OBJECTS OF THE INVENTION

It is an object of the invention to provide an improved method of growing cranberries overcoming some of the problems and shortcomings of the prior art, including those referred to above.

Another object of the invention is to provide commercial quantities of highly desirable cranberries.

Another object of the invention is to provide a high yield of cranberries with superior qualities—particularly for certain popular food uses.

Another object of the invention is to provide a method of increasing the yield of cranberries produced from cranberry plants, including particularly the fruit set (numbers of berries per plant).

Another object of the invention is to provide a method of commercially growing miniature cranberries in reliable commercial quantities.

Another object of the invention is to provide a method of growing parthenocarpic cranberries in reliable commercial quantities.

Another object of the invention is to provide a method of growing cranberries utilizing gibberellin to increase fruit set and to decrease mass of mature cranberries.

Another object of the invention is to provide a method of increasing fruit set in cranberry plants without harming crops in future years.

Still another object of the invention is to provide a high commercial yield of substantially all miniature cranberries.

Yet another object of the invention is to provide a high commercial yield of parthenocarpic cranberries.

Another object of the invention is to provide a maximum yield of cranberries from a cranberry plant.

How these and other objects are accomplished will become apparent from the following descriptions.

### SUMMARY OF THE INVENTION

This novel invention is a yield of miniature cranberries and method of producing such a yield of cranberries. The invention represents a significant advance over the state of the art by providing substantially consistent novel beneficial characteristics of mature cranberries in a cranberry crop through use of a novel commercial-scale process which involves treating cranberry plants during their bloom period.

The invention is based at least in part on the discovery that yields of miniature cranberries can be consistently grown, that cranberry plants can be treated so that they consistently have high fruit sets and that each of these results can be achieved on a commercial scale. Furthermore, the novel miniature cranberries are highly desirable and highly valued by various cranberry purchasers.

The novel method for growing miniature and parthenocarpic cranberries comprises the application of a plant-growth regulating composition to cranberry plants during the plants' bloom period in an amount such that the resulting cranberries have a mature mass of less than about 0.75 grams/cranberry.

The application of the composition to the cranberry plants preferably takes place during the plants' mid-bloom period. Such a period roughly occurs when about 50-90% of the flowers on the plant have opened. More preferably, the composition is applied when about 60-80% of flowers on the plants have opened. Most preferably, the composition is applied when about 70% of flowers on the plants have opened.

The preferred plant-growth regulating composition includes gibberellin, also known as gibberellic acid (GA), as an active ingredient and is applied to the plants in an aqueous solution. More preferably, the plant-growth regulating composition is a mixture of GA₄ and GA₇, though other compositions, including GA₃, GA₄ or GA₇ alone or in various mixtures, can be used to regulate plant growth.

The solution applied to the plants preferably has a composition concentration of about 25-350 ppm. Effective commercial application of the composition to the cranberry plants preferably uses about 10-80 grams of active ingredient (GA) per acre covered by cranberry plants. Preferably about 60-100 gallons of solution including the active ingredient are applied per acre. While multiple applications can be used in the novel method, it is preferred that the composition is applied to the plants as a single step, i.e., in a single day.

Effective commercial application requires little or no run-off such that virtually all of the active ingredient remains on the plants to be absorbed thereby. Effective commercial application also requires that substantially all of each cranberry plant is covered by the solution. Methods of commercial application can be performed using typical agricultural spraying equipment, including aerial, irrigation injection and ground-driven application equipment. In an alternative method, the composition may be applied to the plants via dry application to the ground and taken to the plant by rain. As used herein, “commercial” application refers to mass application techniques as known in the agricultural field.

The cranberry plants treated by the novel method preferably have fruit sets of at least about 80%. More preferably, the cranberry plants treated by the novel method have fruit sets of at least about 90%. Most preferably, the cranberry plants treated by the novel method have fruit sets of nearly 100%. Such regular annual high fruit sets are unknown in the prior art and are a benefit of this novel process.

While the novel method results in cranberries which have mature masses of less than about 0.75 grams/cranberry, it is more preferred that the cranberries have mature masses of about 0.2-0.6 grams/cranberry. Even more preferably, the cranberries have mature masses of about 0.3-0.5 grams/cranberry.

The invention is also a method of increasing fruit set on cranberry plants which comprises the step of commercially applying to cranberry plants a plant-growth regulating composition in an amount and at a time such that the plants have fruit sets of at least about 80%. More preferably the application of the composition causes the plants to have fruit sets of at least about 90%. Most preferably the application of the composition results in fruit sets of nearly 100%.

The application step preferably takes place during the mid-bloom period of the cranberry plants. Such a period occurs when about 50-90% of flowers on the plants have opened. More preferably, the composition is applied when about 60-80% of flowers on the plants have opened. Most preferably, the composition is applied when about 70% of flowers on the plants have opened.

The composition has an active ingredient which preferably is gibberellin. The composition is preferably dissolved in an aqueous solution for application to the cranberry plants. A mixture of GA₄ and GA₇ preferably comprises the composition, though other combinations of GA₃, GA₄ and GA₇ can be utilized.

In the preferred embodiment the concentration of composition within the solution is about 25-350 ppm. Using such a concentration, the composition is commercially applied to cranberry plants and is applied in an amount so that about 10-80 grams of active ingredient are effectively applied per acre covered by plants. Preferably about 60-100 gallons of the solution are applied per acre, and such application is performed in a single applying step, i.e., the application is performed in a single 24 hour period.

The preferred method results in cranberries having a mature mass less than about 0.75 grams/cranberry. More preferably, the cranberries have a mature mass of about 0.2-0.6 grams/cranberry. Most preferably, the cranberries have a mature mass of about 0.3-0.5 grams/cranberry.

The application of the composition to the cranberry plants is performed by typical commercial procedures which provide for mass application to a large number of plants. The composition is preferably sprayed onto the plants. Ground-driven equipment can be used to provide such spraying.

The novel yield of cranberries from a cranberry plant is unique in that at least about 50% of the cranberries have mature masses of less than about 0.6 grams/cranberry. More preferably, at least about 75% of the cranberries have mature masses of less than about 0.6 grams/cranberry. Most preferably, nearly 100% of the cranberries have mature masses of less than about 0.6 grams/cranberry.

More specifically, it is preferred that substantially all, meaning the great majority, of the cranberries have mature masses of less than about 0.75 grams/cranberry. More preferably, the majority of the cranberries in a yield have mature masses of about 0.2-0.6 grams/cranberry. It is most preferred that the majority of the cranberries in a yield have mature masses of about 0.3-0.5 grams/cranberry.

The novel yields of cranberries result from fruit sets of at least 80%. More preferably, the yields of cranberries result from fruit sets of at least 90%. Most preferably, the yields of cranberries result from fruit sets of nearly 100%.

Such yields are produced by applying to the plant a plant-growth-regulating composition during the bloom period of the plant, typically when 50-90% of flowers on the plant have opened. The novel yields are more preferably produced by applying to the plant a plant-growth-regulating composition when about 60-80% of flowers on the plant have opened.

The preferred plant-growth-regulating composition includes an active ingredient which is GA. Preferably, an aqueous solution containing the composition is applied to the cranberry plant. The preferred composition is a mixture of GA₄ and GA₇, certain mixtures of GA₃, GA₄ or GA₇ can be used. The preferred concentration of composition within the solution is about 25-350 ppm for effective application of the solution to the cranberry plants.

Effective application requires little or no run-off such that virtually all of the active ingredient remains on the plant to be absorbed thereby. Methods of application can be performed using typical agricultural spraying equipment, including aerial, irrigation injection and ground-driven application equipment.

The solution is preferably applied in an amount so that about 10-80 grams of active ingredient are effectively applied per acre covered by plants. About 60-100 gallons of the solution are applied per acre of cranberry plants in order to provide the proper amount of active ingredient to each plant. Such an application is performed in one step, i.e., in a 24 hour period.

Cranberry Fruit Set

“Fruit set” describes the persistence and development of an ovary or associated tissues following blossoming. It is calculated as a percent of the number of flowers successfully developing into fruit. Failure of the fruit to set and develop is a common occurrence in fruit crops. Typical cranberry fruit set ranges between about 20-40%, occasionally up to 50% on newer cultivars.

There has been a constant demand from cranberry growers to increase fruit set. However, it has been atypical to have consistent, year after year fruit set above 50-60%.

Use of Gibberellin as a Plant Growth Regulator

Plant growth regulators are organic substances, natural or synthetic, that in low concentrations regulate plant growth and development by modifying the response of plants at one or more stages of development in ways beyond those which result from environmental factors such as nutrient and sunlight supply. Several compounds or groups of compounds, including auxins, gibberelins, cytokinins, ethylene, abscisic acid, jasmonic acid, and braxinosteroids, are plant growth regulators.

All gibberellins are acidic compounds and are therefore called gibberellic acids (GA). As used elsewhere herein, the terms “gibberellin,” “gibberellic acid,” and “GA” are synonymous and are intended to refer to the group of plant growth regulators classified as gibberellin, the acidic derivatives thereof or to the compounds which convert to gibberellin when applied to plants. Different subscripts are used, i.e., GA₃, GA₄, GA₇, to distinguish the various compounds within the gibberellin category. However, each compound has the formula C₁₉H₂₂O₆, 346.

GA is a huge group of tetracyclic diterpenoid cabrolylic acids that share an ent-gibberellane skeleton:

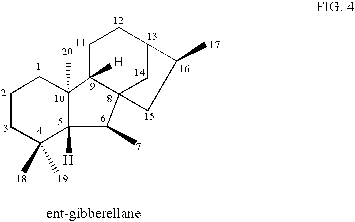

GA is used in agriculture to regulate protein synthesis and stem elongation, overcome dormancy and facilitate rapid germination of seed, enhance flowering on young, immature plants, increase fruit set with more rapid growth of the fruit, protect against frost damage, inhibit root formation of cuttings, and stimulate stem elongation by stimulating cell division and elongation.

In most uses GA application improves fruit set and fruit growth, maturation and ripening. For instance, it is known to use GA in young tart and sweet cherries to reduce flowering and fruiting which maximizes growth. GA is used in mature tart cherries to increase the fruiting capacity by stimulating the development of lateral shoots and spurs. Such application of GA is typically 3-4 weeks after full bloom.

In grapes, in which 100% fruit set is standard, application of GA results in parthenocarpicism and increased grape size. For blueberries, which also typically have 100% fruit set, application of GA ensures 100% fruit set without pollination but does not affect berry size.

The Relationship Between Gibberellin and Cranberry Plants

While the use of GA is known to increase fruit mass and/or fruit set in cherries, grapes, blueberries and similar fruits, successful commercial use of GA on cranberries has not been achieved due to the cranberry plant's unique flowering structure, among other factors. As discussed above, cranberry plants typically allow 20-50% of their flowers to form fruit. The remaining 80-50% are aborted by the plant to guarantee sufficient reserves for forming fully developed fruit by the end of the season.

Nearly all of a cranberry plant's terminal buds are forming at the exact same time and location as the flowers. GA causes elongation of terminal buds on cranberries. Therefore, if GA were applied to cranberry plants in a similar manner as used with grape or blueberry plants, the cranberry plants would experience excessive elongation of the terminal buds which would cause the abortion of terminal buds and reduce yields the following season, possibly eliminating the entire crop for that year.

One of the earliest studies concerning GA and cranberry plants was published in 1978 by Nai-Chia Luke and Paul Eck who studied the affects on gibberellin-like activity in cranberry plants during treatment with nitrogen and daminozide (GA was not applied to the plants, rather the levels of GA naturally occurring in the plants was recorded). The study found that cranberry leaves in both uprights and runners were consistently higher in GA activity than was stem tissue, suggesting that the cranberry leaf is the principal site for GA synthesis or storage.

A study performed in 1986-87 by Elden J. Stang and Brain A. Birrenkott analyzed the effects of the application of growth regulators, including gibberellin, at stages of 50% bloom, 100% bloom and 7 days postbloom. The applications resulted in fruit sets of 51-53% compared to 26% for the untreated control, slight reduction of mean berry weight and an unaffected total yield. Less concentrated applications at early bloom, full bloom, 7 days postbloom and 14 days postbloom resulted in increased fruit sets of 34-57% compared to 22% in the control, unaffected berry weight and increased yield of 60%.

No known academics nor commercial growers have been able to attain the high fruit sets which have been realized by the novel method. Nor have any known academics or commercial growers been able to grow entire yields of cranberries wherein substantially all the cranberries have mature masses of less than 0.75 g/cranberry.

The Novel Use of Gibberellin on Cranberry Plants

GA application during the bloom period adjusts the hormonal balance in the cranberry plant, making all, or nearly all, flowers set fruit. The bloom period typically lasts about four weeks. The resulting fruit are typically entirely seedless, either because the fruit are extremely small or the GA caused seeds to abort.

The timing of application of the composition is of critical importance because if the GA is applied too early or too late, the extremely high fruit set may not be realized and the mature cranberries may have diverse masses or the GA may adversely affect crops in future years.

The composition is preferably applied at temperatures above 60F. and below 90F. The penetration of the GA into the plant tissue is enhanced by slow drying. Therefore, low humidity and windy conditions should be avoided if possible.

It is believed that the properly timed application of GA onto cranberry plants results in the plants evenly dispersing their stored carbohydrates to all flowers which have set. For instance, a cranberry plant which is not treated with GA may have eight flowers which were pollinated and set and four grams of stored carbohydrates. The plant will typically provide only four of the berries with carbohydrates, thus allowing each of the four berries to grow to their typical size of 0.9-2.0 grams.

However, the same cranberry plant, if treated with GA, will behave much differently. Instead of providing carbohydrates to only four of the flowers which set, it will distribute its carbohydrates to all eight. Thus, the plant produces twice as many cranberries at lower masses.

### DETAILED DESCRIPTION OF PREFERRED EMBODIMENTS

GA is commercially applied to cranberry plants during the cranberry plants' bloom period, preferably when about 70% of the plants' flowers have opened. The GA is preferably a mixture of GA₄ and GA₇, though other combinations of GA compounds can be utilized. The GA is preferably dissolved in a solvent and mixed with water for application. The solution which is applied to the plants has a GA concentration of about 25-350 ppm. It is preferred that about 60-100 gallons of solution including the GA are applied per acre covered by cranberry plants. Therefore, about 10-80 grams of GA are applied per acre covered by cranberry plants.

Effective commercial application of the plant growth regulator to the cranberry plants requires that each plant is substantially covered by the solution and there is little or no run-off. This parameters are most easily met by use of typical ground-driven application equipment. The application of the solution to the cranberry plants is preferably performed in one step to eliminate drying of the solution before the GA can be absorbed by the cranberry plants' foliage.

As a result of the novel application, the cranberry plants have fruit sets approaching 100%. In addition, substantially all, or the great majority, of the resulting cranberries have mature masses of less than 0.75 grams/cranberry, with an average mature mass of about 0.2-0.6 grams. More preferably, a majority or substantially all of the cranberries have mature masses of about 0.2-0.6 grams/cranberry with an average mature mass of 0.3-0.5 grams.

While the principles of the invention have been shown and described in connection with specific embodiments, it is to be understood that such embodiments are by way of example and are not limiting.

1. A method for commercially growing miniature cranberries comprising applying to cranberry plants a plant-growth-regulating composition during the bloom period in an amount such that the cranberries have a mature mass of less than about 0.75 grams/cranberry.

2. The method of claim 1 wherein the applying step is during the mid-bloom period.

3. The method of claim 1 wherein there is a single applying step.

4. The method of claim 2 wherein the composition is applied when about 50-90% of flowers on the plants have opened.

5. The method of claim 4 wherein the composition is applied when about 60-80% of flowers on the plants have opened.

6. The method of claim 5 wherein the composition is applied when about 70% of flowers on the plants have opened.

7. The method of claim 1 wherein the composition has an active ingredient which includes gibberellin.

8. The method of claim 1 wherein a solution including the composition is applied to the plants.

9. The method of claim 8 wherein the solution is an aqueous solution.

10. The method of claim 8 wherein the composition is a mixture of GA₄ and Ga₇.

11. The method of claim 10 wherein the concentration of composition within the solution is about 25-350 ppm.

12. The method of claim 10 wherein the composition is commercially applied to cranberry plants and the solution has a concentration and is applied in an amount so that about 10-80 grams of active ingredient are effectively applied per acre covered by plants.

13. The method of claim 12 wherein about 60-100 gallons of the solution are applied per acre.

14. The method of claim 1 wherein the plants have fruit sets of at least about 80%.

15. The method of claim 1 wherein the plants have fruit sets of at least about 90%.

16. The method of claim 1 wherein the cranberries have a mature mass of about 0.2-0.6 gram/cranberry.

17. The method of claim 1 wherein the cranberries have a mature mass of about 0.3-0.5 gram/cranberry.

18. The method of claim 1 wherein application is by spraying.

19. The method of claim 18 application is by ground-driven application equipment.

20. A method of increasing fruit set on cranberry plants comprising commercially applying to the cranberry plants of a plant-growth-regulating composition in an amount and at a time such that the plants have a fruit set of at least about 80%.

21. The method of claim 20 wherein the applying step is during the mid-bloom period.

22. The method of claim 20 wherein there is a single applying step.

23. The method of claim 21 wherein the composition is applied when about 50-90% of flowers on the plants have opened.

24. The method of claim 23 wherein the composition is applied when about 60-80% of flowers on the plants have opened.

25. The method of claim 24 wherein the composition is applied when about 70% of flowers on the plants have opened.

26. The method of claim 20 wherein the composition has an active ingredient which is gibberellin.

27. The method of claim 20 wherein a solution including the composition is applied t o the plants.

28. The method of claim 27 wherein the solution is an aqueous solution.

29. The method of claim 27 wherein the composition is a mixture of GA₄ and GA₇.

30. The method of claim 29 wherein the concentration of composition within the solution is about 25-350 ppm.

31. The method of claim 29 wherein the composition is commercially applied to cranberry plants and the solution has a concentration and is applied in an amount so that about 10-80 grams of active ingredient are effectively applied per acre covered by plants.

32. The method of claim 31 wherein about 60-100 gallons of the solution are applied per acre.

33. The method of claim 20 wherein the plants have fruit sets of at least about 90%.

34. The method of claim 20 wherein cranberries produced by the plants after application of the composition have a mature mass less than about 0.75 grams.

35. The method of claim 20 wherein cranberries have a mature mass of about 0.2-0.6 gram/cranberry.

36. The method of claim 20 wherein cranberries have a mature mass of about 0.3-0.5 gram/cranberry.

37. The method of claim 20 wherein application is by spraying.

38. The method of claim 37 application is by ground-driven application equipment.

39. A yield of miniature cranberries from a cranberry plant wherein substantially all the cranberries have mature masses of less than about 0.75 grams.

40. The yield of claim 39 wherein the majority of the cranberries have mature masses of about 0.2-0.6 grams.

41. The yield of claim 39 wherein the majority of the cranberries have mature masses of about 0.3-0.5 grams.

43. The yield of claim 39 wherein the yield results from a fruit set of at least 80%.

44. The yield of claim 39 wherein the yield results from a fruit set of at least 90%.

45. The yield of claim 39 wherein the yield is produced by applying to the plant a plant-growth-regulating composition during the bloom period of the plant.

46. The yield of claim 45 wherein the yield is produced by applying to the plant a plant-growth-regulating composition when about 50-90% of flowers on the plant have opened.

46. The yield of claim 45 wherein the yield is produced by applying to the plant a plant-growth-regulating composition when about 60-80% of flowers on the plant have opened.

47. The yield of claim 45 wherein the plant-growth-regulating composition includes an active ingredient which is gibberellin.

48. The yield of claim 45 wherein a solution including the composition is applied to the plant.

49. The yield of claim 48 wherein the solution is an aqueous solution.

50. The yield of claim 49 wherein the composition is a mixture of GA₄ and GA₇.

51. The yield of claim 48 wherein the composition is commercially applied to cranberry plants and the solution has a concentration and is applied in an amount so that about 10-80 grams of active ingredient are effectively applied per acre covered by plants.

53. The yield of claim 52 wherein about 60-100 gallons of the solution are applied per acre.

54. The yield of claim 45 wherein there is a single applying step.
